(19) United States
(12) Patent Application Publication
(10) Pub. No.: US 2026/0357083 A1
(43) Pub. Date: Nov. 12, 2026

(54) ZINC RICH EPOXY COATING

(71) Applicant: PPG Coatings (Kunshan) Co., Ltd., Jiangsu (CN)

(72) Inventors: Shijie Kang, Jiangsu (CN); Langfeng Fan, Jiangsu (CN); Shaohua Ma, Jiangsu (CN); Ping Jin, Jiangsu (CN)

(73) Assignee: PPG Coatings (Kunshan) Co., Ltd., Jiangsu (CN)

(21) Appl. No.: 19/739,993

(22) Filed: Jul. 13, 2026

Related U.S. Application Data
(63) Continuation of application No. 18/254,536, filed on Nov. 18, 2021, now Pat. No. 12,709,689.

(30) Foreign Application Priority Data
Nov. 26, 2020 (CN) 202011349753.5

(51) Int. Cl. C09D 5/10; C09D 7/20; C09D 7/61; C09D 163/00

(52) U.S. Cl. CPC C09D 5/106; C09D 7/20; C09D 7/61; C09D 163/00

(57) ABSTRACT

The present disclosure relates to a coating composition that includes: a resin component containing epoxy resins and petroleum resins; zinc particles in an amount of at least 65 wt.-%, based on the total solid weight of the coating composition; metallic salts of phosphorous acid; and hardeners. In addition, the present disclosure relates to a multi-part coating formed from the coating composition, a method for preparing the coating composition, and a substrate coated with the coating composition.

### CROSS REFERENCE TO RELATED APPLICATIONS

This application is a continuation of U.S. application Ser. No. 18/254,536, filed May 25, 2023, which is a US Nationalization of PCT Application No. PCT/CN2021/131431, filed Nov. 18, 2021, which claims priority to CN application No. 202011349753.5, filed Nov. 26, 2020, each of which are incorporated herein by reference.

### FIELD OF THE DISCLOSURE

The present disclosure relates to an anti-corrosion zinc rich, epoxy resin based coating composition. More specifically, the present disclosure relates to an anti-corrosion coating composition having improved corrosion resistance, rapid drying and curing rate, and low density.

### BACKGROUND

Anti-corrosion coatings are widely used in various industrial fields to protect coated substrates from external erosions, in particular used for protecting iron and steel structures, for example, industrial structures, such as bridges, oil refinery equipments, petrochemical industry production equipments, power plant equipments, storage tanks, cranes, windmills, and steel structural parts of civil buildings and the like.

Such coatings may be based on several resin systems, for example silicates, epoxy resins, polyurethanes, polysiloxanes, alkyd resin and the like. Among them, epoxy resin based anti-corrosion coating is the one that are widely used.

For example, CN111117418A proposes a coating composition comprising two parts, wherein part A comprises an epoxy resin, and part B comprises b1) polyetheramine, b2) an alkyl diamine containing an aromatic ring and b3) an epoxy resin.

Moreover, it has been found that some metals, for example zinc, may be added to primer for enhancing the corrosion resistance of the coating. When playing an anti-corrosion effect in the coating, metals such as zinc can act as a sacrificed anode material to protect the steel or iron substrate which acts as a cathode.

For example, CN104603213A proposes an anti-corrosion zinc containing primer composition, which comprises a silicate/ester based binder system, zinc particles, hollow glass microspheres and conductive pigments. That patent intends to enhance the corrosion resistance by means of adding zinc in a cost effective way and with a limited amount.

In addition, CN106068310A also proposes a solution of adding zinc particles in multiple binder systems. CN104745044A proposes a zinc rich primer using activation technique, wherein zinc powders are added to the resin base.

However, the normal corrosion resistance of epoxy coatings cannot satisfy some anti-corrosion demands under special atmospheric environments. Although it may be enhanced by adding zinc, conventional zinc rich epoxy coatings may result in cost rise because of the massive addition of zinc powders or may result in the loss of comprehensive properties and workability. In addition, although hollow microspheres may be added to the zinc rich epoxy coating to decrease the amount of zinc powders in the formulation while keeping the zinc amount in the dry film, there are still needs in improving the corrosion resistance and curing property.

### SUMMARY OF THE DISCLOSURE

In order to solve the above and other problems existing in the prior art, in one aspect, the present disclosure provides a coating composition, comprising:
a resin component containing epoxy resins and petroleum resins;
zinc particles in an amount of at least 65 wt.-%, based on the total solid weight of the coating composition;
metallic salts of phosphorous acid; and
hardeners.

In another aspect, the present disclosure provides a multi-part coating composition, which comprises at least the following two parts:
Part A comprising a resin component, zinc particles and metallic salts of phosphorous acid, wherein the resin component comprises an epoxy resin and a petroleum resin, and the amount of zinc particles is at least 65 wt.-%, based on the total solid weight of the coating composition; and
Part B comprising a hardener.

In still another aspect, the present disclosure provides a method for preparing a coating composition, including providing at least the resin component, zinc particles, metallic salts of phosphorous acid, and the hardener as described above, or providing Part A and Part B comprising these components respectively, and then mixing them.

Finally, the present disclosure also provides a substrate coated with the coating composition of the present disclosure, in particular a steel and iron structure.

The coating composition of the present disclosure provides the improved adhesion to substrates. Meanwhile, the coating composition of the present disclosure also provides balanced comprehensive properties, including enhanced corrosion resistance and rapid drying and curing rate, and the coating composition is of a low density.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

In addition, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “an” epoxy resin, “a” hydrocarbon resin and/or “a” diamine, and the like refer to one or more of any of these items.

The coating composition of the present disclosure can be advantageously formulated into a multi-part coating composition. In the case of a multi-part coating composition, the coating composition of the present disclosure comprises Part A as the base component or the binder of the coating.

The resin component of the coating composition of the present disclosure comprises epoxy resins (also referred to as epoxy compound herein). Suitable epoxy resins have more than one 1,2-epoxy group. They may be liquid type or solid type. Generally, the epoxy equivalent of epoxy resins is from 100 to about 2,000 g/eqv., generally about 150 to 500 g/eqv., such as about 170 to about 350 g/eqv., such as about 180 to about 300 g/eqv. Persons skilled in the art can understand that an epoxy equivalent means the gram number of an epoxy resin containing 1 equivalent epoxy group. Liquid type epoxy resins suitable for the present disclosure have relatively high viscosity and relatively low epoxy equivalent. The liquid type epoxy resin used for the present disclosure has a viscosity at 25 °C from about 8,000 to about 16,000 cps, such as about 10,000 to 12,000 cps. The viscosity is measured according to universal standard method in the field.

In addition, epoxy resins may be saturated or unsaturated, cyclic or acyclic, aliphatic, alicyclic, aromatic or heterocyclic. They may contain substituent(s), such as halogen, hydroxyl and ether group.

The examples of epoxy resins may include a polyepoxide having a 1,2-epoxy equivalent of greater than 1, generally about 2, i.e. having in average about two epoxy groups per molecule. Polyepoxides commonly used as epoxy resins are polyglycidyl ethers of cyclic polyols, for example, polyglycidyl ethers of polyphenols such as bisphenol A, resorcinol, hydroquinone, benzenedimethanol, phloroglucinol and catechol; or polyglycidyl ethers of polyols such as alicyclic polyol, in particular cycloaliphatic polyol, such as 1,2-cyclohexandiol, 1,4-cyclohexandiol, 2,2-bis(4-hydroxylcyclohexyl) propane, 1,1-bis(4-hydroxylcyclohexyl) ethane, 2-methyl-1,1-bis(4-hydroxylcyclohexyl) propane, 2,2-bis(4-hydroxyl-3-tert-butylcyclohexyl) propane, 1,3-bis(methylol)cyclohexane and 1,2-bis(methylol)cyclohexane. The examples of aliphatic polyols include especially trimethylpentylene glycol and neopentylene glycol.

In a preferred embodiment, the epoxy resins of the present disclosure can include, for example, those based on diglycidyl ethers of bisphenol A, bisphenol F, glycerin, novolac and the like. Exemplary suitable polyepoxides are those as described in U.S. Pat. No. 4,681,811, column 5, lines 33 to 58, the referenced parts being incorporated herein by reference.

In another preferred embodiment, the epoxy resins of the present disclosure include those based on bisphenol A, bisphenol F or mixtures thereof.

Commercially available examples of suitable epoxy resins include: Shell Epon 828 (a bisphenol A-epichlorohydrin epoxy resin) and/or the blend of this resin with the difunctional epoxide reactive diluents, such as neopentylene glycol diglycidyl ether, resorcinol diglycidyl ether and cyclohexane dimethanol diglycidyl ether; bisphenol A type liquid epoxy resin, such as NPEL-128E; bisphenol A solid epoxy resin, such as YD-011X75; bisphenol F epoxy resin, i.e. Shell Epon DPL 862 (a bisphenol F-epichlorohydrin epoxy resin); and epoxy novolac resin, such as Epalloy 8250 (an epoxy novolac resin) from CVC in Cherry Hill, N.J., Araldite EPN 1139 from Ciba Geigy, DEN438 from Dow Chemical. These epoxy resins show good chemical resistance. Suitable non-aromatic epoxy resins include diglycidyl ethers of hydronated cyclohexane dimethanol and hydronated bisphenol A type epoxy resin, such as: Epon 1510, Epon 4080E, Heloxy 107 and Epon 1513 (hydronated bisphenol A-epichlorohydrin epoxy resin) from Shell Chemical, Houston, Texas; Santolink LSE-120 from Monsanto in Springfield, Mass; Epodil 757 (cyclohexane dimethanol diglycidyl ether) from Pacific Anchor in Allentown, Pa; Araldite XUGY358 and PY327 from Ciba Geigy in Hawthorne, New York; Epirez 505 from Rhone-Poulene in Louisville, Ky; Aroflint 393 and 607 from Reichold in Pensacola, Florida; and ERL4221 from Union Carbide in Tarrytown, New York. Other suitable non-aromatic epoxy resins include DER 732 and DER 736.

In various embodiments of the present disclosure, the amount of the epoxy resins in the coating composition of the present disclosure is from about 3 to about 25 wt.-%, preferably 5 to 20 wt.-%, more preferably from about 7 to 15 wt.-%, based on the total weight of the coating composition. In a preferred embodiment of the present disclosure, the coating composition can comprise simultaneously both liquid type epoxy resin and solid type epoxy resin as the epoxy resin component. Preferably, the liquid type epoxy resin and the solid type epoxy resin are selected from those as described above, more preferably bisphenol A or F type epoxy resins. In such embodiments, the amount of liquid type epoxy resin may be from about 0.5 to about 15 wt.-%, preferably about 1 to about 10 wt.-%, more preferably about 1 to about 7 wt.-%. In these embodiments, the amount of solid type epoxy resin may be from about 1 to about 20 wt.-%, preferably about 2 to about 15 wt.-%, more preferably about 2 to about 12 wt.-%.

Moreover, the resin component of the coating composition of the present disclosure shall comprise petroleum resins. Petroleum resins are also known as hydrocarbon resins. Petroleum resins are thermoplastic resins produced from C5, C9 fractions produced from petroleum cracking through pretreatment, polymerization, distillation, and the like processes. In general, petroleum resins include aliphatic or cycloaliphatic resins based on C5 or cycloaliphatic dienes (such as dicyclopentadiene), and aromatic components based on C9, such as vinyl toluene or indene or aromatic resins and their mixtures. In some cases, petroleum resins also include their hydronated products, i.e. hydronated petroleum resins, such as C5 hydronated petroleum resins or C9 hydronated petroleum resins. Petroleum resins also can include modified petroleum resins, which are liquid resins of low viscosity, and contain inactive hydroxyl in its aromatic functional groups in contrast to the common petroleum resins, and may be used in solventborne, non-solvent type or high solid content epoxy systems. The petroleum resin and modified petroleum resin used in the embodiments of the present disclosure are commercially available.

In various embodiments of the present disclosure, the amount of the petroleum resins in the coating composition of the present disclosure is from about >0 (such as 0.5) to about 10 wt.-%, preferably from about 1 to about 8 wt.-%, more preferably from about 1.5 to 5 wt.-%, based on the total weight of the coating composition.

Preferably, in the coating composition according to the present disclosure, the weight ratio of the epoxy resins to the petroleum resins is in a range of 2 to 10:1, preferably 3 to 8:1, for example about 6:1. The inventors have found that when adding or mixing petroleum resins in the resin component comprising epoxy resins, especially in accord with the above ratios, the inventive coating composition can have the significantly improved hydrophilic and hydrophobic balance.

According to the present disclosure, the coating composition also should comprise zinc particles. In particular, the amount thereof is, based on the total solid weight of the coating composition, at least 65 wt.-%. As used herein, term “particles” means materials in the form of particulates, such as powder or dust and flake, and may be in the form of any shape, such as, for example, spherical, ellipsoidal, cubical, rod-shaped, disk-shaped, prism-shaped, and the like.

As used herein, term “zinc” or “zinc particles” means metal particles substantially consisting of zinc individual particles or having high zinc purity. Suitable purity of zinc particles refers generally to at least 94%, preferably at least 96% or at least 98% or 99% of metallic zinc, based on total weight of particles, such as metal particles marketed as zinc powders or zinc dusts, and also includes metal particles having up to 100% of metallic zinc. The rest part in particles apart from zinc may be other metallic elements or the compounds thereof, and this part may for example be coating layers of the particles or also may be alloy materials formed with zinc. Suitable zinc particles can conform to for example zinc powder specifications according to type II or type III in ASTM D520. In addition, particles of zinc alloys substantially based on zinc as primary metal also may be used as the zinc particles of the present disclosure, so long as they meet the requirement of comprising at least 94% of metallic zinc, based on the total weight of the zinc alloys. Correspondingly, those alloys having zinc as a primary metal but containing other metallic elements at a significant amount, such as more than 6%, for example, zinc alloys comprising 50 wt.-% or more and generally lower than 94%, such as 90% of zinc, are not in the scope of the “zinc” or “zinc particles” of the present application.

The average particle size of zinc particles may be at least 1 μm, such as at least 2 μm, such as at least 5 μm, such as at least 5.5 μm, such as at least 6 μm, and may not be greater than 150 μm, such as no greater than 30 μm, such as no greater than 20 μm, such as no greater than 10 μm, such as no greater than 8 μm. The average particle size of zinc particles may be from 1 to 150 μm, such as 2 to 30 μm, such as 5 to 20 μm, such as 5.5 to 10 μm, such as 6 to 8 μm. The selection of particle size may depend on the expected viscosity and application property of the coatings. The reported average particle sizes herein are average particle sizes provided by zinc particle manufacturers and can be measured by multiple known methods of the present technical field, such as laser diffraction method and the like.

Based on the total solid weight of the coating composition, the coating composition may include at least 65 wt.-% of zinc particles, such as at least 70 wt.-% of zinc particles, such as at least 75 wt.-% of zinc particles, such as at least 80 wt.-% of zinc particles, such as at least 85 wt.-% of zinc particles, and can include no more than 95 wt.-% of zinc particles, such as no more than 90 wt.-% of zinc particles, such as no more than 85 wt.-% of zinc particles. Although the coating composition of the present disclosure may also contain other metal particles, such as those particles of zinc alloy having a zinc content of lower than 94% or aluminum or aluminum alloy and the like, the coating composition preferably include them in a very small amount, such as no more than 5%, 4%, 3% or 1%, based on total solid weight of coating composition, more preferably completely free of other metal particles, including metallic elements (i.e. zero valency) and metals alloy of other metals.

In addition, the zinc particles may be subjected to a surface treatment to modify the surface of the zinc particle. The surface treated zinc particles may comprise a pretreatment layer formed by exposing the zinc particle to a pretreatment composition. As used herein, the term “pretreatment composition” refers to a composition that upon contact with the zinc material reacts with and chemically alters the material surface and binds to it to form a protective layer. The pretreatment composition used to modify the surface of the zinc particles may comprise any known in the art for pretreating zinc material.

Moreover, according to the present disclosure, metallic salts of phosphorous acid shall be used in the coating composition. In the present disclosure, the “salt of phosphorous acid” means an inorganic salt containing phosphorus element in the anion acid group, including phosphate, phosphite, hypophosphite, hydrogen phosphate, dihydrogen phosphate, hydrogen phosphite, dihydrogen phosphite, polyphosphate or polyphosphate and the like, wherein phosphate, polyphosphate and hydrogen phosphate may be preferred. Metals (such as molybdenum) or non-metal (such as silicon) modified forms, such as phosphosilicate can also be used as the salts of phosphorous acid. Metals which are in the cation part of the metallic salts of phosphorous acid include zinc, aluminum, magnesium, calcium, strontium, zirconium, iron, barium and the like. However, preferably, such metals do not comprise alkaline metals.

Therefore, specific examples of suitable metallic salts of phosphorous acid include zinc phosphate, aluminum tripolyphosphate, strontium aluminum polyphosphate, zirconium hydrogen phosphate, and silicon (such as silicate) modified phosphate salt or polyphosphate salt, such as zinc strontium calcium phosphosilicate. Preferably, the metallic salt of phosphorous acid is a metallic salt of phosphate, more preferably zinc phosphate.

The inventors have found that when using metallic salts of phosphorous acid in the zinc rich epoxy resin based coating composition, in particular when for example at least 65 wt.-%, at least 70 wt.-%, more preferably at least 75 wt.-%, particularly preferably at least 80 wt.-% of zinc particles are used in combination with metallic salts of phosphorous acid, much better long term corrosion resistance can be obtained. In addition, it has also been found that controlling the weight ratio of the metallic salts of phosphorous acid to the zinc particles in a range of 1:20 to 1:60, preferably 1:25 to 1:45 is particularly advantageous, especially when the amount of zinc particles exceeds 75 wt.-%.

The coating composition of the present disclosure also comprises a hardener component. The hardener component suitable for epoxy resin particularly comprises an amine component. The amine component generally comprises any compounds that can act as a nitrogen source. According to the embodiments of the present disclosure, the amine component can include protein, polypeptide, amino acid, organic amine, polyamine, ammonia, ammonium salt of monomeric polycarboxylic acid, ammonium salt of polymerized polycarboxylic acid, ammonium salt of inorganic acid, polyetheramines, polyamides, their adducts with epoxy resin such as bisphenol A solid epoxy resin, and their mixture and the like.

In some embodiments, suitable hardener include, for example, polyamine. Non-limited examples of polyamine hardeners include primary or secondary diamines or polyamines, wherein the groups linked to nitrogen atom may be saturated or unsaturated aliphatics, alicyclics, aromatics, aromatic substituted aliphatics, aliphatic substituted aromatics and heterocyclics. Non-limited examples of suitable aliphatic and alicyclic diamine include 1,2-ethylene diamine, 1,2-propylene diamine, 1,8-octane diamine, isophorone diamine, propane-2,2-cyclohexyl amine and the like. Non-limited examples of suitable aromatic polyamines include phenylene diamine and toluene diamine, such as meta-xylylene diamine, o-phenylene diamine and p-toluene diamine. Multicore aromatic diamines, such as 4,4′-biphenyl diamine, methylene diphenyl amine and choloromethylene diphenyl amine are also suitable.

The examples of suitable aliphatic diamines include, but not limited to: ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diaminohexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluene diamine, 2,4′- and/or 4,4′-diamino-dicyclohexylmethane and 3,3′-dialkyl 4,4′-diamino-dicyclohexylmethane (such as 3,3′-dimethyl-4,4′-diamino-dicyclohexyl methane and 3,3′-diethylene-4,4′-diamino-dicyclohexyl methane), 2,4- and/or 2,6-diaminotoluene and 2,4′- and/or 4,4′-diaminodiphenyl methane, or mixtures thereof. Alicyclic diamines are available commercially from Huntsman Corporation (Houston, TX) under the name of JEFFLINK such as JEFFLINK 754. Further aliphatic cyclic polyamines may also be used, such as DESMOPHEN NH 1520 available from Covestro AG and/or CLEARLINK 1000, a secondary aliphatic diamine available from Dorf Ketal. POLYCLEAR 136 (available from BASF/Hansen Group LLC), the reaction product of isophorone diamine and acrylonitrile, is also suitable. Other exemplary suitable polyamines are described in U.S. Pat. No. 4,046,729, column 6, line 61 to column 7, line 26, and in U.S. Pat. No. 3,799,854, column 3, lines 13 to 50, the cited portions of which are incorporated by reference herein. Additional polyamines may also be used, such as ANCAMINE polyamines, available from Evonik Industries.

Suitable polyamides include any of polyamides known in the art. The polyamide used as a hardener is usually a product formed by the condensation of dimer acid (or ester) and polyamines. For example, ANCAMIDE polyamides, available from Evonik Industries.

The hardener may also include polyetheramines. Polyetheramines are compounds having a structure of polyether main chain and further comprises amine groups as terminal active functional groups. Polyetheramines are obtained by aminization of polyethylene glycol, polypropylene glycol or ethylene glycol/propylene glycol copolymer under high temperature and high pressure. By selecting different polyoxyalkyl structure, the reactivity, toughness, viscosity and hydrophilicity and other properties of the polyetheramines can be adjusted. Amine groups provide polyetheramines with reactive properties with a variety of compounds. Polyetheramines that can be used in the present disclosure include polyethermonoamine, polyether diamine, polyether triamine and the like. Specifically, the polyetheramines used in the present disclosure can include poly oxide ethylene diamine, poly oxide propylene diamine, poly oxide butylene diamine, and poly oxide ethylene triamine, poly oxide propylene triamine, poly oxide butylene triamine. The examples of commercially available products of the polyetheramines that can be used in the present disclosure can include, for example, Jeffamine series products. Examples of such polyetheramines include aminated propoxylated pentaerythritols, such as JEFFAMINE XTJ-616, and those represented by Formulas (IV) through (VI).

According to Formula (IV) the polyether amine may comprise or be represented by:

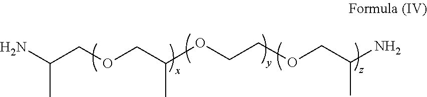

wherein y=0-39, x+z=1-68.

Suitable amine-containing compounds represented by Formula (IV) of the present disclosure include, but are not limited to, amine-terminated polyethylene glycol such as those commercially available from Huntsman Corporation in its JEFFAMINE ED series, such as JEFFAMINE HK-511, JEFFAMINE ED-600, JEFFAMINE ED-900 and JEFFAMINE ED-2003, and amine-terminated polypropylene glycol such as in its JEFFAMINE D series of Huntsman Corporation, such as JEFFAMINE D-230, JEFFAMINE D-400, JEFFAMINE D-2000 and JEFFAMINE D-4000.

According to Formula (V) the polyetheramine may comprise or be represented by:

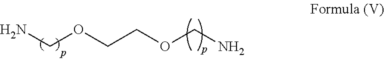

wherein each p independently is 2 or 3.

Suitable amine-containing compounds represented by Formula (V) of the present disclosure include, but are not limited to, amine-terminated polyethylene glycol based diamines, such as Huntsman Corporation's JEFFAMINE EDR series, such as JEFFAMINE EDR-148 and JEFFAMINE EDR-176.

According to Formula (VI) the polyetheramine may comprise or be represented by:

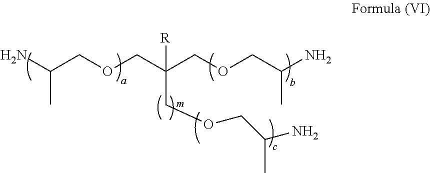

wherein R is H or C₂H₅, m=0 or 1, a+b+c=5-85.

Suitable amine-containing compounds represented by Formula (VI) of the present disclosure include, but are not limited to, amine-terminated propoxylated trimethylolpropane or glycerol, such as Huntsman Corporation's Jeffamine T series, such as JEFFAMINE T-403, JEFFAMINE T-3000 and JEFFAMINE T-5000.

The amine component may also optionally include polyamines containing other functional groups or moieties, for example, 2,4,6-tris(dimethylaminomethyl) phenol.

In a preferred embodiment, in order to achieve faster curing and drying rate, the adducts of the above amine compounds, such as, polyetheramines, polyamides and/or polyamines (like those aliphatic diamines, alicyclic diamines or aromatic diamines as described above) and epoxy resin can be advantageously used as the hardener component. The epoxy resins can be those as described above, such as, epoxy compounds based on bisphenol F or bisphenol A.

In various embodiments of the present disclosure, the hardener component of the coating composition of the present disclosure may also optionally comprise a hardening promoter. The hardening promoter is used for promoting the reactions between the amine component and the epoxy resin. Exemplary hardening promoters include, but not limited to, salicylic acid.

In various embodiments of the present disclosure, the amount of the hardening promoter of the coating composition of the present disclosure is from about 0 to about 3 wt.-%, preferably about 1 to about 2.5 wt.-%, more preferably about 1.5 to about 2 wt.-%, based on the total weight of the hardener component of the coating composition.

In some embodiments of the present disclosure, the coating composition of the present disclosure may also comprise one or more solvents. Solvents commonly used for coating fields can be used for the present disclosure. Specific examples of solvents include, but not limited to: propylene glycol monomethyl ether acetate and the derivatives thereof, acetone, amyl propionate, anisole, benzene, butyl acetate, cyclohexane, dialkyl ethers of ethylene glycol, diethylene glycol dibenzoate, dimethyl sulfoxide, dimethyl formamide, dimethoxybenzene, ethyl acetate, isopropanol, isobutanol, methyl cyclohexanone, cyclopentanone, methyl ethyl ketone, methyl isobutyl ketone, methyl propionate, propylene carbonate, tetrahydrofuran, toluene, xylene, benzyl alcohol, 2-methoxyethyl ether, 3-propylene glycol methyl ether, and mixtures thereof.

In various embodiments of the present disclosure, the amount of one or more solvents in the coating composition of the present disclosure may be from about 5 to 15 wt.-%, preferably about 7 to 12 wt.-%, more preferably about 8 to about 11 wt.-%, based on the total weight of the coating composition.

In various embodiments of the present disclosure, the coating composition of the present disclosure may also optionally comprise one or more additives, including, but not limited to thixotropic agent, wetting and dispersing agent, fillers, pigments, and the like.

Thixotropic agents are used for improving and/or maintaining the rheology of the coating composition and can prevent zinc powder particles and other fillers in the coating from settling. In various embodiments of the present disclosure, the examples of thixotropic agents in Part A of the coating composition of the present disclosure may include colloidal silicate, hydrated aluminum silicate (bentonite), aluminum tristearate, aluminum monostearate, xanthan gum, chrysotile, calcined silica, hydrogenated castor oil, organically modified clay, polyamide wax and polyethylene wax, and the like. The amount of the thixotropic agent can be selected by the person skilled in the art according to actual needs. For example, the amount of the thixotropic agent of the coating composition of the present disclosure may be from about 0.5 to about 1.5 wt.-%, preferably 0.6 to about 1.1 wt.-%, based on the total weight of the coating composition.

Wetting and dispersing agents can improve the dispersibility of the zinc particles and fillers in the coating. Suitable examples of the wetting and dispersing agents include lecithin, amine alkylated polyhydroxy acid amide, polyester with amino substituted end groups, block copolymer, ethylene polymers, and the like. The amount of the wetting and dispersing agent in the coating composition of the present disclosure may be from about 0.1 to about 0.5 wt.-%, preferably about 0.2 to about 0.4 wt.-%, based on the total weight of the coating composition.

In various embodiments of the present disclosure, the coating composition of the present disclosure, in particular Part A of the composition, may comprise fillers different from zinc particles. The fillers include, but not limited to, talc, silicate, mica, montmorillonite, kaolin, diatomaceous earth, vermiculite, natural and synthetic zeolite, calcium silicate, aluminum silicate, sodium aluminum silicate, hollow microspheres, such as hollow glass microspheres, barium sulfate, calcium carbonate, and the like. In a preferred embodiment of the present disclosure, the coating composition of the present disclosure, in particular Part A of the composition, may comprise talc powders, silicate, or hollow microspheres, such as hollow glass microspheres as the fillers. In a further embodiment, the coating composition of the present disclosure, in particular Part A of the composition, may also optionally comprise barium sulfate as the filler. In various embodiments of the present disclosure, the amount of the fillers in the coating composition of the present disclosure may range from about 2 to about 8% based on the total weight of the coating composition. Particularly preferably, the filler comprises hollow microspheres, such as glass microspheres. The content of the hollow microspheres, such as hollow glass microspheres, is preferably from about 1 to 5% based on the total weight of the composition.

Examples of pigments and/or pigment compositions include, but are not limited to, carbazole dioxazine crude pigment, azos, monoazos, diazos, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, iron oxides, carbon black, carbon fiber, graphite, other conductive pigments and/or fillers, and mixtures thereof.

In various embodiments of the present disclosure, the amount of the pigments and/or pigment compositions in the coating composition of the present disclosure may be in a range of about 0.5 to about 5 wt.-%, such as about 0.5 to about 3 wt.-%, based on the total weight of the coating composition.

The coating composition of the present disclosure can be formulated into a multi-part form. The multi-part system is a term known in the coating fields, meaning that the ingredients of a coating composition are formulated into multiple parts or components which are packed in separate containers, such as waterproof containers. The multi-part coating composition comprises at least the following two parts:
Part A, comprising the resin component, zinc particles and metallic salts of phosphorous acid as defined above, wherein the resin component comprises epoxy resins and petroleum resins and the amount of zinc particles is at least 65 wt.-%, based on the total solid weight of the coating composition; and
Part B, comprising the hardener.

The preparation method of Part A of the coating composition is known to the person skilled in the art. For example, at normal temperature or slightly elevated temperature, each components of Part A are mixed and stirred in a container until a proper viscosity is achieved. Likewise, the preparation method of Part B of the coating composition is known to persons skilled in the art and may be carried out similar to the above preparation method of Part A.

In various embodiments of the present disclosure, prior to using the coating composition of the present disclosure, each components are mixed. In case of a multi-part coating composition, Part A and Part B are mixed. Part A and Part B may be mixed at a stoichiometric ratio of epoxy groups to amine groups of 1:0.5 to 1:0.9. Afterwards, the resulting coating composition is applied onto a substrate. There are no limitations to the method for applying the coating composition of the present disclosure onto a substrate. For instance, the application methods may include brush coating, spray coating, dip coating, roller coating, curtain coating and the like.

The substrates that can be applied with the coating composition of the present disclosure are preferably metal substrates. The metal substrates include various steel substrates, iron substrates, aluminum substrates and the like. Advantageously, the coating composition of the present disclosure may be applied on these substrates as a primer or an underlying coating.

The following Examples are presented for the purpose of more detailed description of the present disclosure. However, the following examples are used for illustrating the disclosure but should not be considered as limited to their details. All parts and percentages in the following Examples and the description are by weight unless otherwise indicated.

### EXAMPLES

### Preparation of Binder Part A1

Procedure of preparation of Binder part A1 was as follows: In a vessel at the room temperature, 10 g of a bisphenol A liquid epoxy resin (NPEL-128E, commercially available from Nan Ya Plastics), 100 g of bisphenol A solid epoxy resin (YD-011X75, commercially available from KUKDO CHEMICAL), 30 g of xylene, 17.7 g of propylene glycol monomethyl ether acetate and 7.3 g of isobutanol were homogeneously mixed, and then 18.1 g of a petroleum resin (SK 120, commercially available from Taiwan Yuen Liang) was added under stirring and allowed to be completely solved. Then, 5.3 g of a polyamide wax (Crayvallac ultra, commercially available from ARKEMA) and 5.3 g of an organic bentonite (BENTONE SD-2, commercially available from ELEMENTIS SPECIALTIES) were added under stirring slowly until being evenly dispersed, with the temperature kept at no more than 40 °C. 2.7 g of a soybean lecithin (TOPCITHIN 50, commercially available from CARGILL), 19.5 g of zinc phosphate (commercially available from Jiangsu Shen Long Zinc Co. Ltd.), and 771.9 g of zinc powders (HX600 to II, commercially available from Jiangsu Shen Long Zinc Co. Ltd.) were added under stirring with the temperature kept at 55 to 60 °C for 30 minutes. Finally, 38.7 g of xylene, and 19.5 g of hollow glass microspheres (GLASS BUBBLES VS5500, commercially available from 3M) were added under stirring until being evenly dispersed.

### Preparation of Binder Part A2 (Comparative)

It was carried out similar to the above the procedure of Preparation of Binder Part A1 of the coating composition of the present disclosure, and weight parts of each components are shown in Table 1. The difference is that no zinc phosphate was used and the amount of the petroleum resin was increased.

### Preparation of Binder Part A3

Procedure of preparation of Binder Part A3 was as follows: In a vessel at the room temperature, 10 g of a bisphenol A liquid epoxy resin (NPEL-128E, commercially available from Nan Ya Plastics), 119.5 g of bisphenol A solid epoxy resin (YD-011X75, commercially available from KUKDO CHEMICAL), 30 g of xylene, 17.7 g of propylene glycol monomethyl ether acetate and 7.3 g of isobutanol were homogeneously mixed, and then 18.1 g of a petroleum resin (SK 120, commercially available from Taiwan Yuen Liang) was added under stirring and allowed to be completely solved. 5.3 g of a polyamide wax (Crayvallac ultra, commercially available from ARKEMA) and 5.3 g of an organic bentonite (BENTONE SD-2, commercially available from ELEMENTIS SPECIALTIES) were added while stirring slowly until being evenly dispersed, with the temperature kept at no more than 40 °C. 2.7 g of a soybean lecithin (TOPCITHIN 50, commercially available from CARGILL), 19.5 g of zinc phosphate (commercially available from Jiangsu Shen Long Zinc Co. Ltd.) and 800 g of zinc powders (HX600 to II, commercially available from Jiangsu Shen Long Zinc Co. Ltd.) were added under stirring, with the temperature kept at 55 to 60 °C for 30 minutes. Finally, 45.1 g of xylene and 19.5 g of hollow glass microspheres (GLASS BUBBLES VS5500, commercially available from 3M) were added under stirring until being evenly dispersed.

### Preparation of Binder Part A4

Procedure of Binder Part A4 was as follows: In a vessel at the room temperature, 42.5 g of a bisphenol A liquid epoxy resin (NPEL-128E, commercially available from Nan Ya Plastics), 28.3 g of bisphenol A solid epoxy resin (YD-011X75, commercially available from KUKDO CHEMICAL), 30 g of xylene, 17.7 g of propylene glycol monomethyl ether acetate, and 7.3 g isobutanol were homogeneously mixed, and then 18.1 g of a petroleum resin was added (SK 120, commercially available from Taiwan Yuen Liang) under stirring and allowed to be completely solved. 5.3 g of a polyamide wax (Crayvallac ultra, commercially available from ARKEMA) and 5.3 g of an organic bentonite (BENTONE SD-2, commercially available from ELEMENTIS SPECIALTIES) were added under stirring slowly until being evenly dispersed, with the temperature kept at no more than 40 °C. 2.7 g of a soybean lecithin (TOPCITHIN 50, commercially available from CARGILL), 19.5 g of zinc phosphate (commercially available from Jiangsu Shen Long Zinc Co. Ltd.), and 752.4 g of zinc powders (HX600 to II, commercially available from Jiangsu Shen Long Zinc Co. Ltd.) were added under stirring, with the temperature kept at 55 to 60 °C for 30 minutes. Finally, 41.4 g xylene, and 19.5 g hollow glass microspheres (GLASS BUBBLES VS5500, commercially available from 3M) were added under stirring until being evenly mixed.

### Preparation of Binder Part A5 (Comparative)

It was carried out similar to the above procedure of Preparation of Binder Part A4 of the coating composition of the present disclosure, and weight parts of each components are shown in Table 1. The difference is that no zinc phosphate was used and the amount of the petroleum resin was increased.

### Preparation of Binder Part A6 (Comparative)

It was carried out similar to the above procedure of Preparation of Binder Part A4 of the coating composition of the present disclosure, and weight parts of each components are shown in Table 1. The difference is that no petroleum resin was used.

### Preparation of Binder Part A7 (Comparative)

It was carried out similar to the above procedure of Preparation of Binder Part A4 of the coating composition of the present disclosure, and weight parts of each components are shown in Table 1. The difference is that no petroleum resin, zinc phosphate, hollow glass microspheres were used, but the filler talc powders were added.

### Preparation of Binder Parts A8 and A9 (Comparative)

It was carried out similar to the above procedure of Preparation of Binder Part A7, and weight parts of each components are shown in Table 1. The difference is that the fillers talc powders were added and the amount of zinc particles was correspondingly decreased.

The components and amounts shown in the following Table 1 were used to prepare individual Binder Parts.

TABLE 1
Composition of Binder Parts

| | | A2 | | | A5 | A6 | A7 | A8 | A9 |
|---|---|---|---|---|---|---|---|---|---|
| | A1 | (Comp.) | A3 | A4 | (Comp.) | (Comp.) | (Comp.) | (Comp.) | (Comp.) |
| Components | Weight, g | | | | | | | | |
| Bisphenol A liquid epoxy resin | 10 | 10 | 10 | 42.5 | 42.5 | 48.5 | 57.5 | 57.5 | 57.5 |
| Bisphenol A solid epoxy resin | 100 | 100 | 119.5 | 28.3 | 28.3 | 32.3 | 38.2 | 38.2 | 38.2 |
| Petroleum resin | 18.1 | 37.68 | 18.1 | 18.1 | 37.68 | — | — | — | — |
| Xylene | 68.7 | 71.82 | 75.1 | 71.4 | 76.32 | 66 | 61.5 | 61.5 | 61.5 |
| Isobutanol | 7.3 | 7.3 | 7.3 | 7.3 | 7.3 | 7.3 | 7.3 | 7.3 | 7.3 |
| Propylene glycol monomethyl | 17.7 | 17.7 | 17.7 | 17.7 | 17.7 | 17.7 | 17.7 | 17.7 | 17.7 |
| ether acetate | | | | | | | | | |
| Polyamide wax | 5.3 | 5.3 | 5.3 | 5.3 | 5.3 | 5.3 | 5.3 | 5.3 | 5.3 |
| Organic bentonite | 5.3 | 5.3 | 5.3 | 5.3 | 5.3 | 5.3 | 5.3 | 5.3 | 5.3 |
| Soybean lecithin | 2.7 | 2.7 | 2.7 | 2.7 | 2.7 | 2.7 | 2.7 | 2.7 | 2.7 |
| Hollow glass microspheres | 19.5 | 19.5 | 19.5 | 19.5 | 19.5 | 19.5 | — | — | — |
| Zinc phosphate | 19.5 | — | 19.5 | 19.5 | — | 19.4 | — | — | — |
| Talc powders | — | — | — | — | — | — | 27.9 | 124.5 | 224.5 |
| Zinc powders | 771.9 | 771.9 | 800 | 752.4 | 752.4 | 771.9 | 776.6 | 680 | 580 |
| Total weight | 1046 | 1049.2 | 1100 | 990 | 995 | 995.9 | 1000 | 1000 | 1000 |

### Hardener Part B1

The components and amounts shown in the following Table 2 were used to prepare Hardener Part B1.

TABLE 2
Composition of Hardener Part B1

| | Amount | | |
|---|---|---|---|
| Components | (wt %) | Manufacturer | Name |
| Polyamide | 26.6 | KUKDO | G-640P |
| | | CHEMICAL | |
| 2,4,6-tris(dimethyl- | 5 | EVONIK | ANCAMINE |
| aminomethyl)phenol | | INDUSTRIES | K54 |
| Xylene | 23.5 | Mitsubishi | |
| | | Chemical | |
| Isobutanol | 22.6 | Dow Chemical | |
| Bisphenol A solid | 22.3 | KUKDO | YD-011X75 |
| epoxy resin | | CHEMICAL | |

The preparation procedure of Hardener part B1 was as follows: In an iron vessel at the room temperature, part of the solvents xylene and isobutanol and polyamide, as well as 2,4,6-tris(dimethylaminomethyl) phenol were added and mixed homogeneously. Bisphenol A solid epoxy resin was added under stirring. Finally, the remaining solvents were added and mixed homogeneously. It was placed at the room temperature for at least 3-day prior to use.

### Hardener Part B2

The components and amounts shown in the following Table 3 were used to prepare Hardener Part B2.

TABLE 3
Composition of Hardener Part B2

| | Amount | | |
|---|---|---|---|
| Components | (wt %) | Manufacturer | Name |
| Meta-xylene diamine | 16.7 | Mitsubishi Gas | MXDA |
| | | Chemical Company | |
| 2,4,6-tris(dimethyl- | 4 | EVONIK | ANCAMINE |
| aminomethyl)phenol | | INDUSTRIES | K54 |
| Polyoxypropylene triamine | 16.1 | HUNTSMAN | JEFFAMINE |
| | | | T-403 |
| Bisphenol F epoxy resin | 20.8 | HUNTSMAN | ARL GY285 |
| Xylene | 22.7 | Mitsubishi | |
| | | Chemical | |
| Isobutanol | 5.7 | Dow Chemical | |
| Benzyl alcohol | 14 | Luxi Chemical | |

The preparation procedure of Hardener Part B2 was as follows: In a beaker at the room temperature, part of the solvents xylene and isobutanol and meta-xylene diamine were added and mixed homogeneously. Bisphenol F epoxy resin was added under stirring, and temperature was raised to 90 to 100 °C, allowing the reaction for 1 hour. After the temperature was lowered to 70 to 75 °C, polyoxypropylene triamine, 2,4,6-tris(dimethylaminomethyl) phenol, benzyl alcohol and the remaining solvents were added and mixed homogeneously.

### Hardener Part B3 (Comparative)

The components and amounts shown in the following Table 4 were used to prepare Hardener Part B2.

TABLE 4
Composition of Hardener Part B3

| | Amount | | |
|---|---|---|---|
| Components | (wt %) | Manufacturer | Name |
| Polyamide | 40.6 | KUKDO | G-640P |
| | | CHEMICAL | |
| 2,4,6-tris(dimethyl- | 5 | EVONIK | ANCAMINE |
| aminomethyl)phenol | | INDUSTRIES | K54 |
| Xylene | 16.8 | Mitsubishi | |
| | | Chemical | |
| Isobutanol | 13.7 | Dow Chemical | |
| Benzyl alcohol | 13.5 | Luxi Chemical | |
| Bisphenol A liquid | 10.4 | Nan Ya Plastics | NPEL-128E |
| epoxy resin | | | |

The preparation procedure of Hardener Part B3 was as follows: In an iron vessel at the room temperature, benzyl alcohol, solvents xylene and isobutanol, polyamide, and 2,4,6-tris(dimethylaminomethyl) phenol were added and mixed homogeneously. Bisphenol A liquid epoxy resin was added under stirring and mixed homogeneously. It was placed at the room temperature for at least 3-day prior to use.

### Coating Formulation Example 1

At the normal temperature, Binder Part A1 and Hardener Part B1 were combined. The stoichiometric ratio of binder part to hardener part was 1:0.75, and the volumetric ratio of binder to hardener part was 85:15.

### Coating Formulation Example 2 (Comparative)

At the normal temperature, Binder part A2 and Hardener Part B1 were combined. The stoichiometric ratio of binder part to hardener part was 1:0.78, and the volumetric ratio of binder to hardener part was 85:15.

### Coating Formulation Example 3

At the normal temperature, Binder part A3 and Hardener Part B2 were combined. The stoichiometric ratio of binder part to hardener part was 1:0.76, and the volumetric ratio of binder to hardener part was 90:10.

### Coating Formulation Example 4

At the normal temperature, Binder part A4 and Hardener Part B1 were combined. The stoichiometric ratio of binder part to hardener part was 1:0.75, and the volumetric ratio of binder to hardener part was 77.5:22.5.

### Coating Formulation Example 5 (Comparative)

At the normal temperature, Binder part A5 and Hardener Part B1 were combined. The stoichiometric ratio of binder part to hardener part was 1:0.79, and the volumetric ratio of binder to hardener part was 80:20.

### Coating Formulation Example 6 (Comparative)

At the normal temperature, Binder part A6 and Hardener Part B1 were combined. The stoichiometric ratio of binder part to hardener part was 1:0.75, and the volumetric ratio of binder to hardener part was 80:20.

### Coating Formulation Example 7 (Comparative)

At the normal temperature, Binder part A6 and Hardener Part B2 were combined. The stoichiometric ratio of binder part to hardener part was 1:0.73, and the volumetric ratio of binder to hardener part was 90:10.

### Coating Formulation Example 8 (Comparative)

At the normal temperature, Binder part A7 and Hardener Part B3 were combined. The stoichiometric ratio of binder part to hardener part was 1:0.77, and the volumetric ratio of binder to hardener part was 80:20.

### Coating Formulation Example 9 (Comparative)

At the normal temperature, Binder part A8 and Hardener Part B3 were combined. The stoichiometric ratio of binder part to hardener part was 1:0.81, and the volumetric ratio of binder to hardener part was 80:20.

### Coating Formulation Example 10 (Comparative)

At the normal temperature, Binder part A9 and Hardener Part B3 were combined. The stoichiometric ratio of binder part to hardener part was 1:0.87, and the volumetric ratio of binder to hardener part was 80:20.

### Property Tests:

### 1. Drying Property Test

A blade applicator with 150 μm opening was used. The resulting coating composition was blade coated onto a glass bar. The drying property of the coating was tested (ASTM D1640). Test results were shown in Table 5 below.

### 2. Salt Spray Resistance Test ASTM B117

The coatings of individual Examples as described above were applied onto sand blasted Sa2.5 carbon steel panels of 150 mm×75 mm×5 mm (length*width*thickness), and the dry film thicknesses was 100 μm. Coat film was allowed to be completely cured by dying at room temperature for 14 days. Salt Spray Resistance Test was conducted according to ASTM B117. Test results were shown in Table 5 below.

### 3. Humidity and Heat Resistance Test ASTM D 2247

The coatings of individual Examples as described above were applied onto sand blasted Sa2.5 carbon steel panels of 150 mm×75 mm×5 mm (length*width*thickness), and the dry film thicknesses was 100 μm. Coat film was allowed to be completely cured by dying at room temperature for 14 days. Humidity and heat resistance test was conducted according to ASTM D 2247. Test results were shown in Table 5 below.

### 4. Cyclic Aging Test ISO12944-9

The coatings of individual Examples as described above were applied onto sand blasted Sa2.5 carbon steel panels of 150 mm×75 mm×5 mm (length*width*thickness), and the dry film thicknesses was 60 μm. Then an epoxy intermediate coat was sprayed at a dry film of 170 μm, and then a polyurethane topcoat was sprayed at a dry film of 50 μm. Coated films were allowed to be completely cured by drying at room temperature for 14 days. According to the conditions in ISO12944-9, 25 cycles of Cyclic Aging Test were conducted. The conditions of one cycle of Cyclic Aging Test are 72-hour UVA (ISO 16474-3, Method A), 72-hour Salt Spray Test (ISO9227), frozen at −20 °C for 24 hours. Test results were shown in Table 5 below.

TABLE 5
Test Results of Coatings

| | | 2 | | | 5 | 6 | 7 | 8 | 9 | 10 |
|---|---|---|---|---|---|---|---|---|---|---|
| Coating formulations | 1 | (Comp.) | 3 | 4 | (Comp.) | (Comp.) | (Comp.) | (Comp.) | (Comp.) | (Comp.) |
| Stoichiometric ratio of binder | 1:0.75 | 1:0.78 | 1:0.76 | 1:0.75 | 1:0.79 | 1:0.75 | 1:0.73 | 1:0.77 | 1:0.82 | 1:0.87 |
| part to hardener part | | | | | | | | | | |
| Volumetric ratio of binder | 85:15 | 85:15 | 90:10 | 80:20 | 80:20 | 77.5:22.5 | 90:10 | 80:20 | 80:20 | 80:20 |
| part to hardener part | | | | | | | | | | |
| Weight ratio of binder part | 94.1:5.9 | 94:6 | 96:4 | 92.2:7.8 | 93:7 | 91.4:8.6 | 96:4 | 93.2:6.8 | 92.6:7.4 | 92.1:7.9 |
| to hardener part | | | | | | | | | | |
| Density (g/L) | 2.36 | 2.28 | 2.40 | 2.37 | 2.28 | 2.42 | 2.37 | 2.75 | 2.57 | 2.42 |
| Zinc powder content in dry | 80.5% | 80.4% | 80.9% | 81.2% | 81.0% | 80.3% | 80.7% | 82.9% | 71.6% | 60.9% |
| film | | | | | | | | | | |

Drying Test, according to ASTM D1640

| | | | | | | | | | | |
|---|---|---|---|---|---|---|---|---|---|---|
| Dry-to-touch time (hour) | 0.5 | 0.5 | 0.5 | 0.5 | 0.5 | 0.5 | 0.5 | 2.5 | 2.5 | 2.5 |
| Dry-hard time (hour) | 1 | 1 | 1 | 1 | 1 | 1 | 1 | 3.0 | 3.0 | 3.0 |

Salt Spray Resistance Test, 1000 hour, according to ASTM B117

| | | | | | | | | | | |
|---|---|---|---|---|---|---|---|---|---|---|
| Surface blistering, ASTM | No | No | No | No | No | Yes | Yes | No | Some | Yes |
| D714 | | | | | | | | | | |
| Surface rusting, ASTM | No | Some | No | No | Some | No | Some | No | Some | Yes |
| D1654 | | | | | | | | | | |

Humidity and Heat Resistance Test, 1000 Hours, according to ASTM D 2247

| | | | | | | | | | | |
|---|---|---|---|---|---|---|---|---|---|---|
| Surface blistering, ASTM | No | No | No | No | No | No | Yes | No | No | No |
| D714 | | | | | | | | | | |
| Surface rusting, ASTM | No | No | No | No | No | No | No | No | No | No |
| D1654 | | | | | | | | | | |

Cyclic Aging Test ISO12944-9

| | | | | | | | | | | |
|---|---|---|---|---|---|---|---|---|---|---|
| Surface blistering | No | No | No | No | No | No | No | No | No | No |
| Corrosion at scribe (mm) | 3.00 | 3.61 | 2.76 | 2.41 | 3.42 | 3.08 | 3.52 | 3.87 | 4.50 | 4.97 |
| Pull-off force (MPa) | 11.1 | 10.8 | 10.8 | 15.1 | 11.2 | 10.6 | 8.5 | 15.8 | 14.2 | 15.3 |

As can be seen from the above various test results, the coating composition of the present disclosure can decrease the density of the zinc rich epoxy coating and reduce the amount of zinc powders, meanwhile obtaining the significant improvements in terms of drying property and corrosion resistance (Salt Spray Resistance Test, Humidity and Heat Resistance Test and Cyclic Aging Test) by optimizing the ratios between metallic salts of phosphorous acid, petroleum resins and epoxy resins, and, in certain cases, by further adding hollow glass microspheres.

It will be appreciated by skilled artisans that modifications may be made to the present disclosure without departing from the concept disclosed in the foregoing description. Accordingly, it is to be understood that specific aspects detailed herein are merely illustrative and not to limit the present disclosure. The present disclosure would be entailed the entire scope of the appended claims and their entire equivalents.

1. A coating composition, comprising:
a resin component comprising an epoxy resin and a petroleum resin;
zinc particles in an amount of at least 75 wt.-%, based on the total solid weight of the coating composition;
a metallic salt of phosphorous acid; and
a hardener.

2. The coating composition of claim 1, wherein the petroleum resin is included at up to 10 wt.-%, based on the total weight of the coating composition.

3. The coating composition of claim 1, wherein the weight ratio of the epoxy resin to the petroleum resin is in a range of 2:1 to 10:1.

4. The coating composition of claim 1, wherein the metallic salt of phosphorous acid comprises phosphate, phosphite, hypophosphite, hydrogen phosphate, dihydrogen phosphate, hydrogen phosphite, dihydrogen phosphite and polyphosphate, phosphates or polyphosphates modified with silicon, or a mixture thereof.

5. The coating composition of claim 1, wherein the epoxy resin is included at 3 to 25 wt.-% based on the total weight of the coating composition

6. The coating composition of claim 1, wherein the epoxy equivalent of the epoxy resin is 100 to 2,000 g/eqv.

7. The coating composition of claim 1, wherein the epoxy resin includes both liquid type epoxy resin and solid type epoxy resin.

8. The coating composition of claim 7, wherein the liquid type epoxy resin is included at 0.5 to 15 wt.-%, and the solid type epoxy resin is included at 1 to 20 wt.-%, based on total weight of the coating composition.

9. The coating composition of claim 1, wherein the hardener comprises a polyamine, and/or a primary or secondary diamine.

10. The coating composition of claim 9, wherein groups linked to a nitrogen atom of the hardener include a saturated or unsaturated aliphatic, alicyclic, aromatic, aromatic substituted aliphatic, aliphatic substituted aromatic, heterocyclic, or a mixture thereof.

11. The coating composition of claim 1, further comprising glass microspheres included at 1 to 5 wt.-%, based on the total weight of the composition.

12. The coating composition of claim 1, wherein the epoxy resin comprises an epoxy resin that is saturated, unsaturated, cyclic, acyclic, aliphatic, alicyclic, aromatic, heterocyclic, unsubstituted, substituted, or a mixture thereof.

13. The coating composition of claim 1, wherein the petroleum resin comprises an aliphatic or cycloaliphatic resin based on a C5 or cycloaliphatic diene, an aromatic component based on C9, a hydrogenated product, or a mixture thereof.

14. The coating composition of claim 1, wherein the zinc particles are at least 94% pure, have an average particle size from 1 to 150 μm, are present in the coating composition in an amount of no more than 95 wt % based on the total weight of the composition, and/or are surface treated.

15. The coating composition of claim 1, wherein the composition comprises no more than 5 wt % metal particles other than zinc.

16. The coating composition of claim 1, wherein the metallic salt of phosphorus acid does not include an alkaline metal salt.

17. The coating composition of claim 1, further comprising a hardening promoter, a solvent, a thixotropic agent, a wetting and dispersing agent, a filler, a pigment, or mixtures thereof.

18. A substrate coated with the coating composition of claim 1.

19. The substrate of claim 18, wherein the substrate comprises iron, steel, aluminum, alloys thereof, or mixtures thereof.

20. The substrate of claim 18, wherein the substrate is part of a vehicle.
